(19) United States
(12) Patent Application Publication
(10) Pub. No.: US 2011/0320927 A1
(43) Pub. Date: Dec. 29, 2011

(54) Methods and Apparatus Utilizing XooML: Cross (X) Tool Markup Language

(75) Inventor: William Paul Jones, Kirkland, WA (US)

(73) Assignee: UNIVERSITY OF WASHINGTON, Seattle, WA (US)

(21) Appl. No.: 13/077,392

(22) Filed: Mar. 31, 2011

Related U.S. Application Data
(60) Provisional application No. 61/320,264, filed on Apr. 1, 2010.

(51) Int. Cl. G06F 17/00

(52) U.S. Cl. 715/234

(57) ABSTRACT

Methods and apparatus are presented related to one or more cross-tool markup language (XooML) fragments. A document including a XooML fragment is assembled. A XooML fragment includes tool-independent attribute(s) and tool-dependent attribute(s). The document is presented. A selection of a portion of the presented document is received. The selected portion of the document corresponds with an associated XooML fragment. In response to the selection, an item is presented that corresponds to the selected portion of the document. The item can be presented using a software tool such as the herein-described Planz or by another XooML-capable software tool. A tool-independent attribute of the associated XooML fragment specifies the item. The software tool is configured to present the item based on one or more tool-dependent attributes of the XooML fragment.

### CROSS-REFERENCE TO RELATED APPLICATIONS

This application claims the benefit of U.S. Provisional Patent Application No. 61/320,264, filed on Apr. 1, 2010, entitled “System and Method for Organizing Digital Information Into a Personal Unifying Taxonomy”, which is hereby incorporated by reference in its entirety for all purposes.

### GOVERNMENT LICENSE RIGHTS

This invention was made with U.S. government support under grant number 0534386 awarded by the National Science Foundation. The U.S. government has certain rights in the invention.

### BACKGROUND

Unless otherwise indicated herein, the materials described in this section are not prior art to the claims in this application and are not admitted to be prior art by inclusion in this section.

Various technologies can be utilized to plan one or more tasks. One common and simple approach is to make a plan using pencil and paper. For example, a typical pencil-and-paper plan can include a simple list of items to be accomplished. Computerized tools, such as word processors, presentation/drawing programs, spreadsheets, e-mail and other communication applications, and project-planning software, can be used to plan tasks as well. In some cases, the plan may refer to and perhaps include multiple types of information, such as web pages, e-mail messages, paper documents, and other types of information.

### SUMMARY

In a first aspect, a method is provided. A document is assembled at a document-presentation device. The document includes one or more Cross Tool Mark-Up Language (XooML) fragments. A XooML fragment includes one or more tool-independent attributes and one or more tool-dependent attributes. The document is presented using the document-presentation device. A selection of a portion of the document is received using the document-presentation device. The selected portion of the document corresponds to a XooML fragment. In response to the selection, an item that corresponds to the selected portion of the document is presented. Presenting the item includes utilizing a software tool executing on the document-presentation device. The associated XooML fragment includes a tool-independent attribute specifying the item. The software tool is configured to present the item based on one or more tool-dependent attributes of the associated XooML fragment.

In a second aspect, an article of manufacture is provided. The article of manufacture includes instructions that, upon execution by a processor, cause the processor to perform functions comprising: (i) assembling a document comprising one or more Cross Tool Mark-Up Language (XooML) fragments, where a XooML fragment includes a tool-independent attribute and a tool-dependent attribute; (ii) presenting the document; (iii) receiving a selection of a portion of the document, where the selected portion of the document corresponds to an associated XooML fragment; and (iv) in response to the selection, presenting an item that corresponds to the selected portion of the document, where the item is presented using a software tool, where the selected XooML fragment includes a tool-independent attribute specifying the item, and where the software tool is configured to present the item based on at least one tool-dependent attribute of the associated XooML fragment.

In a third aspect, a document-presentation device is provided. The document-presentation device includes a presentation device and one or more processors. The one or more processors are configured to: (i) assemble a document including one or more Cross Tool Mark-Up Language (XooML) fragments, where at least one XooML fragment includes a tool-independent attribute and a tool-dependent attribute, (ii) present the document via the presentation device, (iii) receive a selection of a portion of the document, where the selected portion of the document is associated with a corresponding XooML fragment, and (iv) in response to the selection, present an item that corresponds to the selected portion of the document, where the item is presented on the presentation device using a tool, where the corresponding XooML fragment comprises a tool-independent attribute specifying the item, and where the tool is configured to present the item based on one or more tool-dependent attributes of the corresponding XooML fragment.

### BRIEF DESCRIPTION OF THE FIGURES

In the figures, similar symbols typically identify similar components, unless context dictates otherwise.

FIG. 1 depicts a network in accordance with an example embodiment.

FIG. 2 is a block diagram of a computing device in accordance with an example embodiment.

FIG. 3A shows an example view of a plan generated by Planz in accordance with an example embodiment.

FIG. 3B shows an example file system view for part of the example plan shown in FIG. 3A in accordance with an example embodiment.

FIG. 3C shows an example XooML fragment for the part of the example plan shown in FIG. 3B, in accordance with an example embodiment.

FIG. 4A shows an example view of a plan in which an item has been deleted using Planz in accordance with an example embodiment.

FIG. 4B shows an example file system view for part of the example plan shown in FIG. 4A in accordance with an example embodiment.

FIG. 4C shows an example XooML fragment for the part of the example plan shown in FIG. 4B, in accordance with an example embodiment.

FIG. 5A shows an example view of a plan after an item has been inserted using Planz in accordance with an example embodiment.

FIG. 5B shows an example file system view for part of the example plan shown in FIG. 5A in accordance with an example embodiment.

FIG. 5C shows an example XooML fragment for the part of the example plan shown in FIG. 5B, in accordance with an example embodiment.

FIG. 6A shows an example plan after an item has been updated using Planz in accordance with an example embodiment.

FIG. 6B shows an example file system view of the example plan of FIG. 6A in accordance with an example embodiment.

FIG. 6C shows an example XooML document for the example plan of FIG. 6A in accordance with an example embodiment.

FIG. 7 is a flow chart of an example method in accordance with an example embodiment.

### DETAILED DESCRIPTION

Overview

Example embodiments may involve generation of one or more planning-related documents, such as document for a plan of a week-long trip from Seattle to the Grand Canyon and Las Vegas. During the planning process, a person planning the trip can access a number of items: travel brochures, web sites, e-mail, photographs, videos, books, and other sources. To help plan the trip, a person can generate a planning-related document with both planning information and information about the various software applications or “tools” used to present items associated with the plan.

One technique is to generate a document that includes “markup language” or instructions to a computer to present the document and the items. One example markup language is Hyper Text Markup Language (HTML), used to instruct computers on presenting web pages. Another example markup language is eXtensible Markup Language (XML) which provides rules for describing items in computer-readable form. An example markup language based on XML is the Cross (X) Tool Markup Language or XooML. XooML provides rules for tools on presenting items and rules for presenting the document.

More specifically, a XooML “fragment” provides “tool-independent attributes” or rules and information that are independent of a tool presenting the document. An example tool-independent attribute of a XooML fragment is a uniform resource identifier (URI) of an association (described in additional detail herein) within the fragment.

The XooML fragment also provides “tool-dependent attributes” or rules and information that depend on the tool presenting the document. Example tool-dependent attributes include a name of the tool, a time that the tool first accessed the document, and a last time the tool accessed the document.

A XooML fragment can include “associations” that represent any item that is addressable by a URI. Example associations include, but are not limited to, folders, tags, e-mail messages, local documents, and Web pages.

For example, the XooML fragment can also include associations about the items associated with the document. In the trip example above, the items are the travel brochures, e-mails, web links, etc. that can be used to plan the trip. A XooML fragment includes both tool-independent and tool-dependent attributes for each association.

XooML enables organizing information structures that grow and change over time as driven by the internal needs of their owners and not the external demands of tools. For example, XooML fragments can combine to support alternate modes of working with existing structures, such as folder or tag hierarchies or collections of songs, photos, and articles. Fragments can combine to define brand-new structures as well. Fragments can “live” any-where, from the local file system to a database on the Web.

XooML fragments and their associations can include any number of new attributes in support of a specific tool or a class of tools. By specifying tools and tool-dependent attributes for displaying items, XooML organizes the use of familiar software tools, such as e-mail readers, web browsers, file system utilities, image viewers/editors, and the like, for presenting associated items. When tools work interchangeably with the same structure, the costs to try a new tool may be much reduced. Tools can work independently but in aggregate to support a much greater diversity in the needs of people as those needs change over time and with the task at hand.

Any tool that presents XooML fragments can be used to present the “document,” which is at least one data item that can be associated with at least one partial or complete XooML fragment. Then, a variety of presentation methods and displays can be used to present documents, such as but not limited to a word-processing-oriented display, a web page, a time-line oriented display, a graph-oriented display such as a mind map, audio and/or video displays. In some cases, presentation tools and attributes can be used to make the document accessible to wider audiences; for example, using text-to-speech tools can make the document accessible to persons with difficulty in reading computer displays. One example XooML-based tool—Planz—is discussed in detail herein.

An Example Network

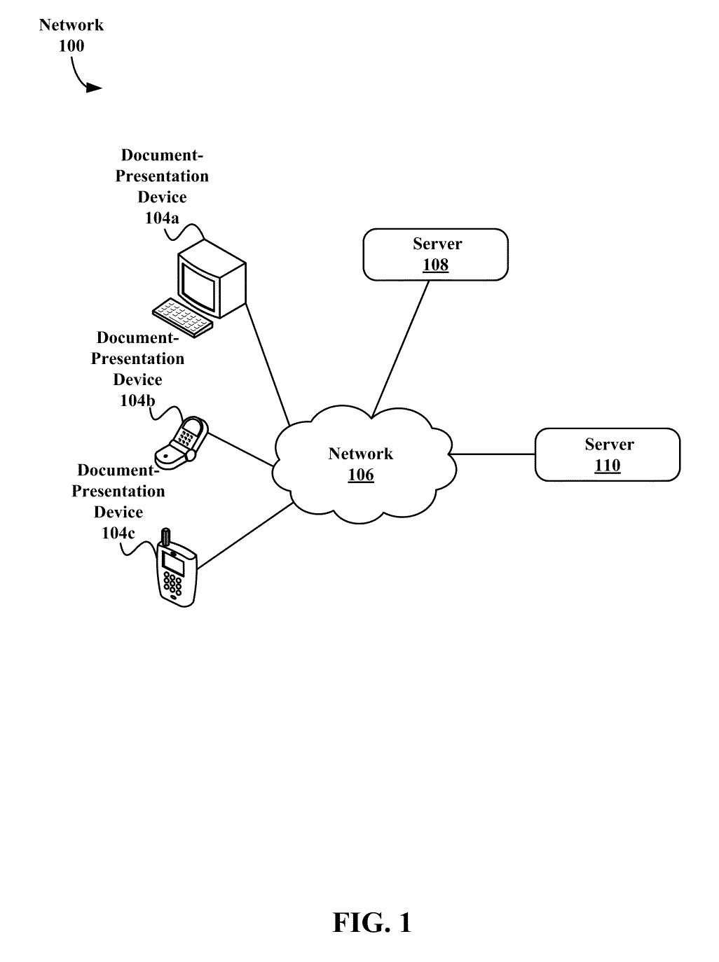

Turning to the figures, FIG. 1 depicts a network 100 in accordance with an example embodiment. In FIG. 1, servers 108 and 110 are configured to communicate, via a network 106, with document-presentation devices 104a, 104b, and 104c. As shown in FIG. 1, document-presentation devices can include a personal computer 104a, a telephone 104b, and a smartphone 104c. More generally, the document-presentation devices 104a, 104b, and 104c (and any additional document-presentation devices) can be any sort of computing device, such as an ordinary laptop computer, desktop computer, network terminal, wireless communication device (e.g., a cell phone or smart phone), and so on.

The network 106 can correspond to a local area network, a wide area network, a corporate intranet, the public Internet, combinations thereof, or any other type of network(s) configured to provide communication between networked computing devices. Server 108 and/or server 110 can provide content to any or all of document-presentation devices 104a-104c and/or recipe server 108. The content can include, but is not limited to, web pages, hypertext, scripts, binary data such as compiled software, images, audio, and/or video. The content can include compressed and/or uncompressed content and/or encrypted and/or unencrypted content. Other types of content are possible as well.

Although FIG. 1 only shows three document-presentation devices and two servers, in other embodiments there can be more or fewer than two servers. In other scenarios, the servers 108 and/or 110 can serve hundreds, thousands, or even more document-presentation devices.

An Example Computing Device

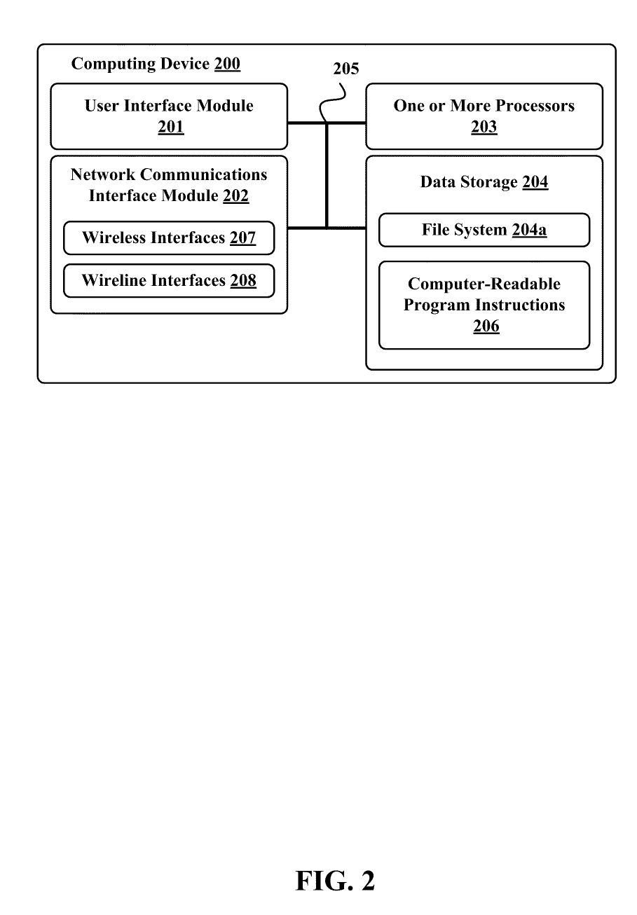

FIG. 2 is a block diagram of a computing device 200 in accordance with an example embodiment. Computing device 200 can be configured to perform one or more functions of document-presentation devices 104a, 104b, and 104c, and/or servers 108 and 110. The computing device 200 can include a user interface module 201, a network communications interface module 202, one or more processors 203, and data storage 204, all of which can be linked together via a system bus, network, or other connection mechanism 205.

The user interface module 201 can be operable to send data to and/or receive data from external user input/output devices. For example, the user interface module 201 can be configured to send/receive data to/from user input devices such as a keyboard, a keypad, a touch screen, a computer mouse, a track ball, a joystick, and/or other similar devices, now known or later developed. The user interface module 201 can also be configured to provide output to user display devices, such as one or more cathode ray tubes (CRT), liquid crystal displays (LCD), light emitting diodes (LEDs), displays using digital light processing (DLP) technology, printers, light bulbs, and/or other similar devices, now known or later developed. The user interface module 201 can also be configured to generate audible output(s), such as through a speaker, speaker jack, audio output port, audio output device, earphones, and/or other similar devices, now known or later developed.

The network communications interface module 202 can include one or more wireless interfaces 207 and/or wireline interfaces 208 that are configurable to communicate via a network, such as the network 106 shown in FIG. 1. The wireless interfaces 207 can include one or more wireless transceivers, such as a Bluetooth transceiver, a Wi-Fi transceiver perhaps operating in accordance with an IEEE 802.11 standard (e.g., 802.11a, 802.11b, 802.11g), a WiMAX transceiver perhaps operating in accordance with an IEEE 802.16 standard, and/or other types of wireless transceivers configurable to communicate via a wireless network. The wireline interfaces 208 can include one or more wireline transceivers, such as an Ethernet transceiver, a Universal Serial Bus (USB) transceiver, or similar transceiver configurable to communicate via a wire, a twisted pair of wires, a coaxial cable, an optical link, a fiber-optic link, or other physical connection to a wireline network. Instructions, program code, and/or data structures may be transmitted via the network communications interface module 202 via a propagated signal on a propagation medium (e.g., electromagnetic wave(s), sound wave(s), etc.).

In some embodiments, the network communications interface module 202 can be configured to provide reliable, secured, compressed, and/or authenticated communications. For each communication described herein, information for ensuring reliable communications (e.g., guaranteed message delivery) can be provided, perhaps as part of a message header and/or footer (e.g., packet/message sequencing information, encapsulation header(s) and/or footer(s), size/time information, and transmission verification information such as cyclic redundancy check (CRC) and/or parity check values). Communications can be compressed and decompressed using one or more compression and/or decompression algorithms and/or protocols such as, but not limited to, one or more lossless data compression algorithms and/or one or more lossy data compression algorithms. Communications can be made secure (e.g., be encoded or encrypted) and/or decrypted/decoded using one or more cryptographic protocols and/or algorithms, such as, but not limited to, DES, AES, RSA, Diffie-Hellman, and/or DSA. Other cryptographic protocols and/or algorithms can be used as well or in addition to those listed herein to secure (and then decrypt/decode) communications.

The one or more processors 203 can include one or more general purpose processors and/or one or more special purpose processors (e.g., digital signal processors, application specific integrated circuits, etc.). The one or more processors 203 can be configured to execute computer-readable program instructions 206 that are contained in the data storage 204 and/or other instructions as described herein.

The data storage 204 can include one or more computer-readable storage media that can be read or accessed by at least one of the processors 203. The one or more computer-readable storage media can include volatile and/or non-volatile storage components, such as optical, magnetic, organic or other memory or disc storage, which can be integrated in whole or in part with at least one of the one or more processors 203. In some embodiments, the data storage 204 can be implemented using a single physical device (e.g., one optical, magnetic, organic or other memory or disc storage unit), while in other embodiments, the data storage 204 can be implemented using two or more physical devices.

Computer-readable storage media associated with data storage 204 and/or other computer-readable media described herein can also include physical and/or non-transitory computer-readable media such as computer-readable media that stores data for short periods of time like register memory, processor cache, and random access memory (RAM). Computer-readable storage media associated with data storage 204 and/or other computer-readable media described herein can also include physical and/or non-transitory computer readable media that stores program code and/or data for longer periods of time, such as secondary or persistent long term storage, like read only memory (ROM), optical or magnetic disks, compact-disc read only memory (CD-ROM), for example. Computer-readable storage media associated with data storage 204 and/or other computer-readable media described herein can also be any other volatile or non-volatile storage systems. Computer-readable storage media associated with data storage 204 and/or other computer-readable media described herein can be considered computer readable storage media for example, or a tangible storage device.

The data storage 204 can include computer-readable program instructions 206 and perhaps additional data. In some embodiments, the data storage 204 can additionally include storage required to perform at least part of the herein-described techniques, methods (e.g., method 700), and/or at least part of the functionality of the herein-described devices and networks. In some other embodiments, data storage 204 can include a file system 204a.

Example Uses for Planz and XooML

The Personal Project Planner, or “Planz” for short, provides a document-like overlay to a personal file system containing files to support organization of other forms of information, such as but not limited to, web links also known as Uniform Resource Locators (URLs) and URIs, e-mail messages, and informal notes.

In some embodiments, Planz includes three levels of operation: a front-end, a back-end file system, and a middle level for XooML fragments. The front-end provides a document-oriented draft or outline view, similar to a basic word processor. The front-end is oriented around “headings” or higher-level parts of a document processed by Planz (or a “Planz document” for short), and “notes” or items of the Planz document. A heading can include sub-headings and notes. The front-end supports: direct text entry or typing to create notes and headings in a Planz document, moving headings and notes within the Planz document, expanding or collapsing headings to respectively reveal or hide content, promotion of notes to be headings, and demotion of headings to be notes.

In some embodiments, dragging-and-dropping an item into an open Planz document creates a link to the item in the open Planz document. Selecting text from an item and dropping the selected text into the Planz document creates a copy of the text in the Planz document in a new note with a link back to the item for the selected text.

While working with a Planz document, other documents can be created and/or e-mail messages can be sent. These other documents and e-mails can be created as usual; e.g., in separate windows from the Planz-document window managed by supporting applications such as a word processing or e-mail application. In addition, Planz can place a link to the document or e-mail near the current insertion point within the Planz document.

For example, suppose a person were drafting a Planz document about taking a trip, and realized that they would like to ask if their friend could join along. Then, the person could edit the Planz document to have a heading such as “Ask Friend to go along” and then send an e-mail to the friend asking about the trip. Planz could then insert a link to a copy of the e-mail after the current insertion point, such as directly after the word “along” in the “Ask Friend . . . ” heading.

Planz documents can link to each other and, in some embodiments, to other information items. In some scenarios, the contents of a linked Planz document linked to a current Planz document can be expanded to be shown within the current Planz document. Planz documents can be saved and/or exported as XML documents, as detailed below, HTML documents, and/or other types of documents.

Planz can assemble Planz documents. In some embodiments, Planz can start at a pre-defined or otherwise specified location in a file system and traverse the file system and/or utilize XooML fragments to assemble the Planz document.

For example, suppose a Planz was directed to start assembling a Planz document in a “Planz/MyTrip” folder of a file system, and that at the “MyTrip” folder in turn contained 3 sub-folders: “Boston”, “London”, and “France”, with the “France” sub-folder additionally containing a “Paris” sub-sub-folder. In these embodiments, Planz can look in the MyTrip folder for a XooML fragment and, upon finding the XooML fragment, can start assembling a Planz document based on the MyTrip XooML fragment and/or contents of the MyTrip folder. Then, by examining the MyTrip folder and/or examining the MyTrip XooML fragment, Planz can find the Boston, London, and France sub-folders, look for XooML fragments in each sub-folder, and add to the assembled Planz document based on the contents of the sub-folders and/or XooML fragments in the sub-folders. Further, by examining either France XooML fragment or France XooML sub-folder, Planz can discover the Paris sub-sub-folder and, add to the assembled Planz document based on the contents of the Paris sub-sub-folder and/or XooML fragments in the Paris sub-sub-folder. Other techniques for assembling Planz documents are possible as well.

As for the back-end, in some embodiments, Planz documents are stored in specific folders or directories within a file system. A heading or subheading of a Planz document corresponds to a file system folder or directory. For example, a Planz document can be stored in a default folder, such as “Projects” or “Planz.” However, Planz can also generate a Planz document for one or more specified folders or directories of a file system.

In some embodiments, links within a Planz document correspond to either local files within the folder or directory, or to shortcuts, which in turn, can point to “information items,” such as but not limited to, files, folders, directories, web pages, e-mail messages, and/or other types of information. In some embodiments, a one-to-one mapping from Planz-document headings/subheadings to file system folders is used. In other embodiments, a one-to-one mapping from Planz-document links to information items is used.

The use of Planz documents with corresponding back-end file system folders and documents permits utilization of widespread operations, like word processing tasks and file system operations, and local storage and control.

At the middle-level between the Planz view and the file system are XooML fragments. Each XooML fragment corresponds to a “plan,” which is part or all of a Planz document. A plan can include an ordered list of associations, each of which may have a link to an information item, such as a file, shortcut, or folder. Each association may correspond to an item in Planz document.

As indicated above, a XooML fragment is factored into “tool-independent” and “tool-dependent” attributes. This factorization is done both at the level of a metadata fragment and each of its associations. A XooML fragment can be considered as a collection of attribute bundles where bundles are identified through a namespace declaration.

If an association has a link to an information item, the portion of the Planz document displaying a “note” or text, images, etc. related to the item can be selected. The note can be presented based on attributes specified in the XooML fragment for note presentation, such as visibility, collapsed status, flag status, due date, font, color, and/or output type (e.g., audio, video, textual). Other attributes for note presentation are possible as well.

Upon selection of the note, Planz coordinates the presentation of the linked information item specified in the corresponding XooML fragment. In particular, Planz invokes a software tool to present the linked information item. In some embodiments, the corresponding XooML fragment can specify the software tool to be used, perhaps including use of a default software tool. For example, upon selection of a note “E-mail from attorney” that is linked to an e-mail, Planz can select a tool to read an associated e-mail message based on information in the XooML fragment for this note. The XooML fragment can either specify a particular e-mail-message tool for use to read the e-mail message and/or can specify that a default e-mail-message tool can be used to read the e-mail message. Many other examples of specifying tools, including specification of default tools, are possible as well.

In particular embodiments, Planz can be the software tool used to present the linked information item. The software tool can be configured to present the item based on one or more tool-dependent attributes of the associated XooML fragment.

In some embodiments, each XooML fragment is stored as a text file within an associated folder. The XooML fragment can be stored in a number of ways depending upon the item that it modifies, user preference, user privileges and available storage. For example, the XooML fragment that modifies a file folder is typically stored within the folder modified by the XooML fragment. In other embodiments, XooML fragments are stored in a separate database. Fragments in such a database can be stored as individual records, perhaps keyed by a URI for the information item (e.g., file folder, web resource, e-mail message) for which the fragment applies.

The presentation of a corresponding Planz document follows a synchronization process between a XooML fragment and files in the associated folder. For example, if an information item has been added to the associated folder, the XooML fragment can be updated to include an item for the newly-added information item. As another example, if a file has been removed from the associated folder, the XooML fragment can be updated to remove item(s) associated with the removed information item.

The synchronization process may discover that sub-folders of the associated folder have been added or deleted. When a sub-folder of the associated folder has been added, a XooML fragment for the added sub-folder can be generated and stored with in the added sub-folder. In response to determining that a sub-folder has been deleted, the XooML fragment for the associated folder can be updated to delete item(s) corresponding to the deleted sub-folder. When a sub-folder of the associated folder has been deleted, typically the XooML fragment for the removed sub-folder is deleted. The XooML fragment for the associated folder can be updated to remove item(s) corresponding to the deleted sub-folder.

1. Plan Creation

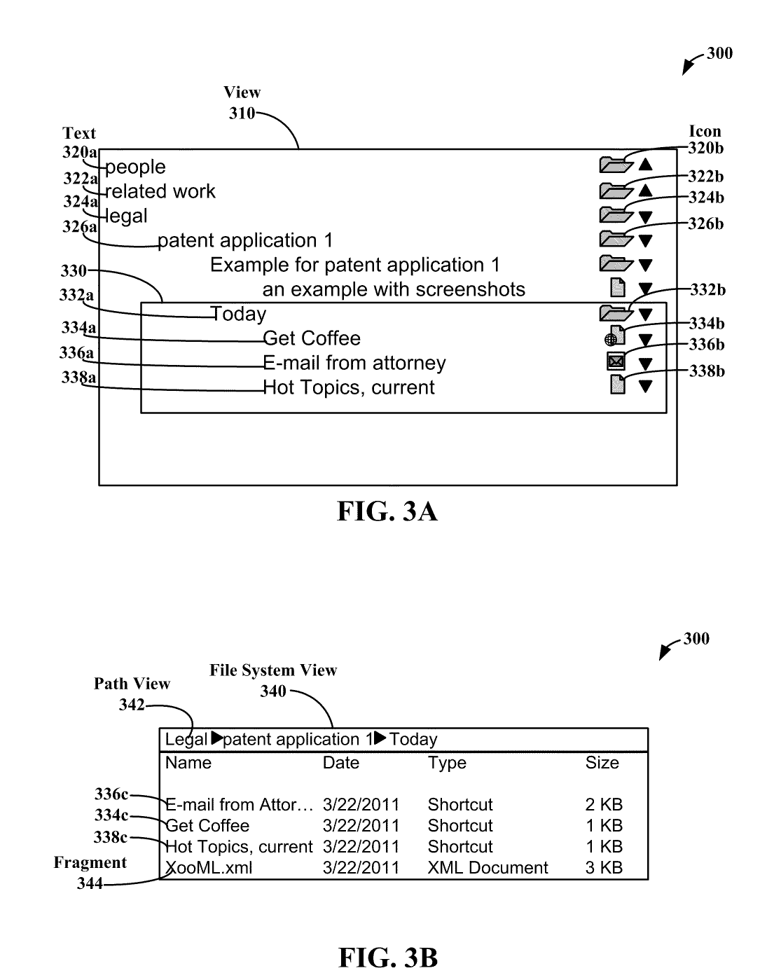

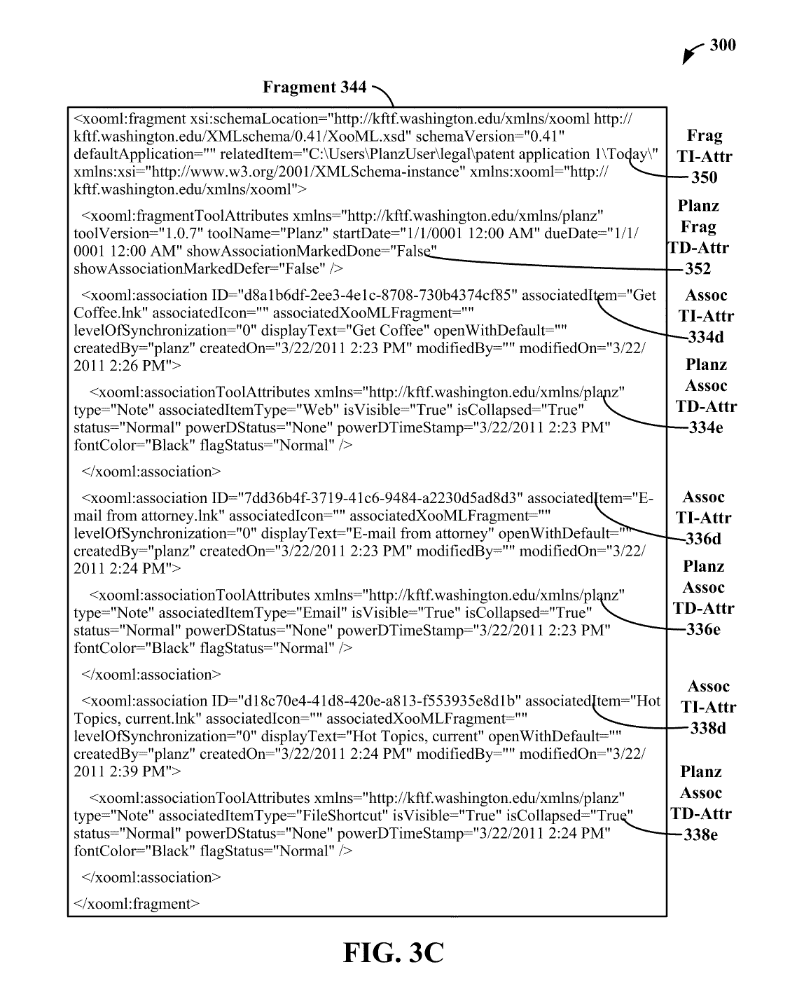

FIGS. 3A, 3B, and 3C together show an example scenario 300 for creating a plan and corresponding XooML fragment using Planz. Each of FIGS. 3A, 3B, and 3C show separate views of the plan at the same time: FIG. 3A shows a Planz-generated view, FIG. 3B shows a file system view, and FIG. 3C shows a corresponding XooML fragment.

In some embodiments, each of the plan, file system, and XooML fragment views shown in FIGS. 3A-3C can be generated using separate tools; while in other embodiments, two or more of the plan, file system, and XooML fragment views can be generated using one tool. In still other embodiments, other views than those shown in FIGS. 3A-3C can be generated and displayed. Examples of these other views include but are not limited to: “mind maps” or graphic views with items radiating from a central node, time-line views with item arranged in time-sequential order, displays showing available/occupied resources, completion status views, Gantt charts, other charts, and graphs. Also, other types of presentations are possible as well, such as but not limited to, audio, video, audio-video, animations, and/or one or more presentation slides.

FIG. 3A shows an example view 310 of a plan generated by Planz in accordance with an example embodiment. View 310 includes a number of items in a Planz documents, including headings and sub-headings. For example, text 320a of “people” is a heading with an associated icon 320b of a folder. Each item, including headings and sub-headings can be presented by Planz with an associated icon representing a type of information item used by the file system for the item. For example, headings, sub-headings, sub-sub-headings, etc. are shown with folder icons.

Headings can be shown as expanded, or with all items under the heading revealed, or un-expanded, or with all items under the heading hidden. FIG. 3A shows that the “people” and “related work” headings are un-expanded as indicated by the triangle next to icons 320b and 322b, respectively, being pointed upward. FIG. 3A shows that the “legal” heading is expanded, as indicated by the triangle next to icon 324b being pointed downward. To change the expanded/un-expanded status of a heading, a user of Planz can click on or otherwise select the corresponding triangle displayed next to icon for the heading, and in response, Planz can toggle the expanded/un-expanded views of the corresponding heading.

FIG. 3A shows text 326a of “patent application 1” is a sub-heading of the “legal” heading, as indicated by indentation of text 326a. FIG. 3A shows box 330 outlining a sub-sub-heading and associated items of the “patent application 1” sub-heading. The sub-sub-heading has text 332a of “Today” and an icon 332b of a folder. Under the sub-sub-heading of “Today”, FIG. 3A shows three items: (1) an item with text 334a of “Get Coffee” and an icon 334b of a web document, (2) an item with text 336a of “E-mail from attorney” and an icon 336b of an e-mail message, and (3) an item with text 338a of “Hot Topics, current” and an icon 338b of a document.

FIG. 3B shows an example file system view 340 of part of the example plan of scenario 300, in accordance with an example embodiment. File system view 340 of FIG. 3B shows an example folder corresponding to the “Today” sub-sub-heading shown in FIG. 3A. The example folder can include a path view 342 that shows parent folder names of “Legal” and “patent application 1” to the “Today” folder.

FIG. 3B also shows names, dates, types and sizes of the items associated with the “Today” sub-sub-header. For example, FIG. 3B shows that, according to file system view 340, item 334c has a name 334c of “Get Coffee”, a date of “Mar. 22, 2011”, a type of “Shortcut”, and a size of “1 KB.” FIG. 3B also shows information about fragment 344, which is a XooML fragment associated with this folder. FIG. 3B shows that fragment 344 has a name of “XooML.xml” and has a type of a “XML document.”

A XooML fragment includes one or more “tool-independent attributes”, each of which is information common to the entire document specified by the XooML fragment and one or more sets of “tool-dependent” attributes, each of which is information common to the entire document but used by a specific tool. Along with the tool-independent and tool-dependent attributes, the XooML fragment includes zero or more “associations.” Each association includes one or more “association-tool-independent attributes” common to the association, and one or more sets of “association-tool-dependent attributes” for use by a specific tool.

As an example, consider a XooML fragment “Basic plan” with two items: “E-mail”, “Document.” Further suppose that two tools—Planz and FreeMindX, which is a brainstorming tool—were used to present the “basic plan.” Then, the XooML fragment for the “basic plan” can have the example structure shown in Table 1 below:

TABLE 1

Basic plan tool-independent attributes
Basic plan tool-dependent attributes for Planz
Basic plan tool-dependent attributes for FreeMindX
E-mail tool-independent attributes
E-mail tool-dependent attributes for Planz
E-mail tool-dependent attributes for FreeMindX
Document tool-independent attributes
Document tool-dependent attributes for Planz
Document tool-dependent attributes for FreeMindX

Continuing this example, suppose that a third tool, “Tool3”, later presented the “Basic plan” XooML fragment. To present the “Basic plan” fragment, the third tool (or other associated software) can modify the “Basic Plan” fragment to add tool-dependent attributes for both the “Basic plan” fragment and each of the two items “E-mail” and “Document.” An example of the modified “Basic Plan” fragment for use by Planz, FreeMindX, and Tool3 is shown below in Table 2.

TABLE 2

Basic plan tool-independent attributes
Basic plan tool-dependent attributes for Planz
Basic plan tool-dependent attributes for FreeMindX
Basic plan tool-dependent attributes for Tool3
E-mail tool-independent attributes
E-mail tool-dependent attributes for Planz
E-mail tool-dependent attributes for FreeMindX
E-mail tool-dependent attributes for Tool3
Document tool-independent attributes
Document tool-dependent attributes for Planz
Document tool-dependent attributes for FreeMindX
Document one tool-dependent attributes for Tool3

FIG. 3C shows an example XooML fragment 344 for the part of the example plan shown in FIG. 3B, in accordance with an example embodiment.

A XooML fragment comprises one or more elements written in the XooML markup language, which, in some embodiments, is based on the XML markup language. A XooML element comprises at least one tag, and can include an opening tag, content, and a closing tag. An opening tag is of the form <tag-identifier [attrib1=“value”, [attrib2=“value2” . . . ]]>, where “tag-identifier” is an identifier of the tag, and attrib1 and attrib2 are optional attributes that modify and/or provide information about the XooML element. Content typically starts after the opening tag. A closing tag delimits the end of the content and is typically denoted as </tag-identifier>. That is, the closing tag starts with the characters “</”, has the same tag-identifier as the opening tag, and ends with the character “>”.

For example, the first line of FIG. 3C, specifying fragment tool-independent attributes (“Frag TI-Attr”) 350, starts with a “<” and then the tag-identifier “xooml:fragment.” The tag for fragment tool-independent attributes 350 specifies seven attributes and corresponding attribute values. The last line of fragment tool-independent attributes 350 ends with a “>”, indicating the end of an opening tag. The corresponding closing tag is shown on the last line of FIG. 3C as “</xooml:fragment>”—the sequence of characters “</” starting a tag indicates that a tag is a closing tag, in contrast to starting a tag with a “<” alone to indicate an opening tag.

Fragment 344 includes fragment tool-independent attributes (“Frag TI-Attr”) 350, and fragment tool-dependent attributes for Planz (“Planz Frag TD-Attr”) 352. For the “Get Coffee” item, fragment 344 includes association tool-independent attributes (“Assoc TI-Attr”) 334d and association tool-dependent attributes for Planz (“Planz Assoc TD-Attr”) 334e. For the “E-mail from attorney” and “Hot Topics, current” items, fragment 345 includes respective association tool-independent attributes 336d and 338d and respective association tool-dependent attributes for Planz 336e and 338e.

FIG. 3C shows that fragment tool-independent attributes 350 include locations of schema for Xml/XooML “xsi.schemaLocation” of “kftf.washington.edu/xmlns/xooml” and “kftf.washington.edu/XMLschema/0.41/XooML.xsd”, a version identifier for the schema “schemaVersion” of “0.41”, a default application of “ ”, a related item specifying a path for the “Today” folder of “C:\Users\PlanzUser\legal\patent application 1\Today\”, and name spaces “xmlns:xsi” of “www.w3.org/2001/XMLSchema-instance” and “xmlns:xooml” of “kftf.washington.edu/xmlns/xooml”. In other embodiments, more or fewer tool-independent attributes are possible.

The schema for Xml/Xooml defines the components of an Xml/Xooml document; that is, according to tool-independent attributes 350, the schema located at “kftf.washington.edu/xmlns/xooml” includes definitions of the components of a XML/XooML document. Tool-independent attributes 350 also specifies two namespaces, or definitions of valid component names: an XML namespace of “www.w3.org/2001/XMLSchema-instance” and a XooML namespace of “kftf.washington.edu/xmlns/xooml”.

FIG. 3C shows that fragment tool-dependent attributes for Planz 352 includes a name space for Planz at “kftf.washington.edu/xmlns/planz”, a tool (Planz) version number of “1.0.7”, a tool name of “Planz”, and start and due dates. Fragment tool-dependent attributes for Planz 352 also includes a “showAssociationMarkedDone” variable with a value of “False” and a “showAssociationMarkedDefer” variable with a value of “False.” In other embodiments, more or fewer tool-dependent attributes for Planz and other tools are possible as well.

FIG. 3C shows that the three sets of association-tool-independent attributes 334d, 336d, and 338d each include attributes for: an association identifier (ID), an associated item which specifies a file name for the association, an associated icon, an associated XooML fragment, a level of synchronization, display text, a name of a tool that created the association (the “createdBy” attribute), a creation date, a name of a tool that modified the association (the “modifiedBy” attribute”), and a modification date. In some embodiments, the associated item attribute can specify information other than a file name; e.g., the associated item attribute can specify a URL or URI. In other embodiments, more or fewer association-tool-independent attributes can be specified as well.

Additionally, FIG. 3C shows that each of the three sets of association-tool-dependent attributes for Planz 334e, 336e, and 338e each include attributes for: a name space, an association type, an associated item type, a visibility flag (“is Visible”), a collapsed flag (“is Collapsed”), a status, a “powerD” status, a “powerD” time stamp, a font color, and a flag status. In other embodiments, more or fewer association-tool-dependent for Planz attributes can be specified as well.

In some embodiments, each tool may modify any tool-independent attributes, at either the fragment or item level, and any of the tool's own tool-dependent attributes. XooML can leverage the xmlns namespace convention of XML to insure that bundles of attributes are uniquely identified by their “owning” tool and to insure that there is no risk of confusion or “collision”; e.g., component name reuse, between the attributes used by different tools. That is, in some embodiments, each tool that presents XooML fragments has its own namespace.

For example, suppose two tools “tool1” and “tool2” both operate on the same XooML fragment but did not have separate namespaces. Then, if both tool1 and tool2 use an attribute named “color”, the specification of the “color” attribute in a XooML fragment by tool1 can affect tool2 (or vice versa) as the attribute “color” collided between tool1 and tool2. In contrast, by use of separate tool-dependent attributes specifying separate name spaces, attributes for tool1 and tool2 need not collide.

By specifying tool-specific name spaces, decentralized development of tools is enhanced. As each separate tool for XooML can provide and adhere to its own name space, only XooML tool-independent attributes has to be coordinated across XooML-using tools.

2. Item Deletion

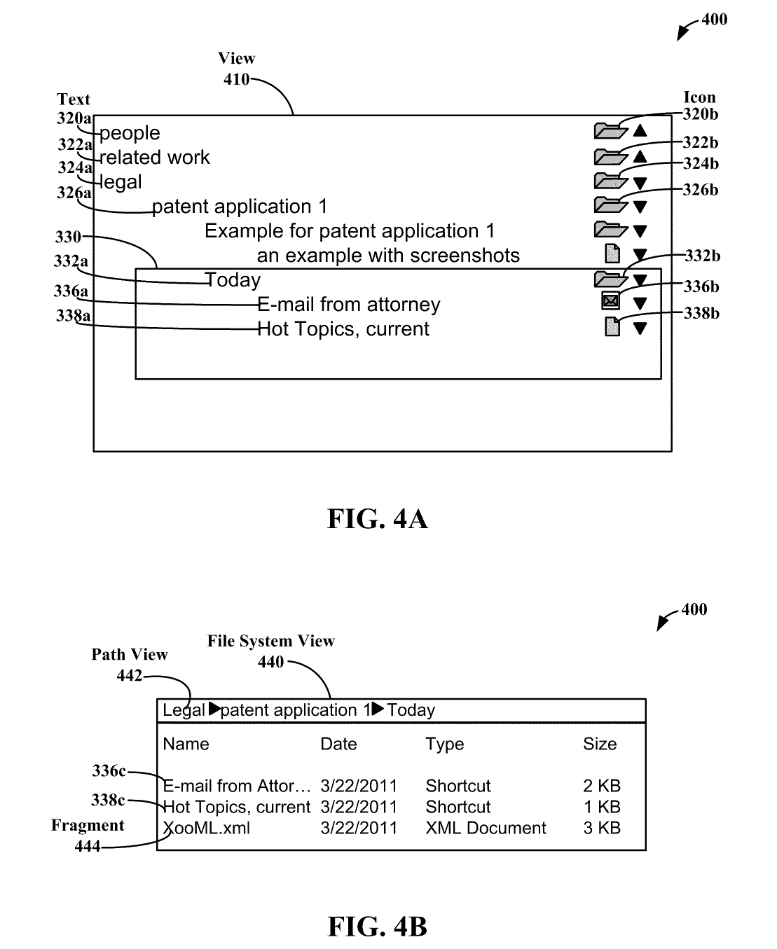

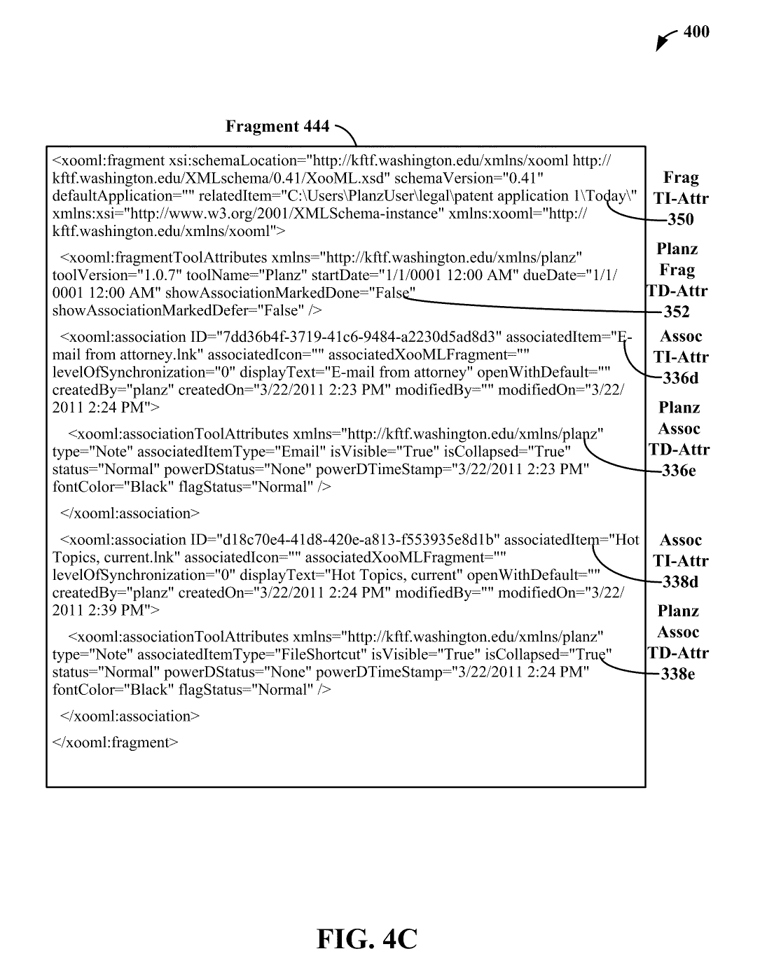

FIGS. 4A, 4B, and 4C together show an example scenario 400 for deleting an item from a plan using Planz. Scenario 400 continues scenario 300 discussed above in the context of FIGS. 3A-3C. Each of FIGS. 4A, 4B, and 4C show separate views of the plan at the same time: FIG. 4A shows a Planz-generated view after deletion of the “Get Coffee” item discussed above in the context of FIGS. 3A-3C, FIG. 4B shows a file system view after deletion of the Get Coffee item, and FIG. 4C shows a corresponding XooML fragment.

FIG. 4A shows an example view 410 for scenario 400, in which an item of a plan has been deleted using Planz in accordance with an example embodiment. View 410 shows that the “Get Coffee” item 334a and 334b has been deleted (the “Get Coffee” item no longer appears in view 410). The remainder of view 410 is the same as view 310 (shown in FIG. 3A).

FIG. 4B shows an example file system view 440 for part of the example plan shown in FIG. 4A in accordance with an example embodiment. FIG. 4B shows that file system view 440 with the Get Coffee item 334c removed. Upon deletion of an item using view 410, Planz updates view 410 to show the item and associated information are deleted; e.g., the web document about “Get Coffee.” Planz also deletes the link, copy, or shortcut to the corresponding information item in an associated folder. As such, FIG. 4B shows that item 334c is not present in the “Today” folder. Planz also updates the XooML fragment 444 to indicate the deletion of the “Get Coffee” item. FIG. 4B shows that the remainder of file system view 440 is the same as file system view 340 (shown in FIG. 3B).

FIG. 4C shows an example XooML fragment 444 for the part of the example plan shown in FIG. 4B, in accordance with an example embodiment. To update a XooML fragment to remove an item, a tool, such as Planz, can remove any tool-independent attributes and tool-dependent attributes specified in the fragment for the item. Fragment 444 shows removal of the “xooml:association” tag corresponding to the “Get Coffee” item; that is, attributes 334d (which includes the opening tag) and 334e and corresponding closing tag, have been removed. The remaining portions of fragment 444 are the same as fragment 344 (shown in FIG. 3C).

3. Item Insertion

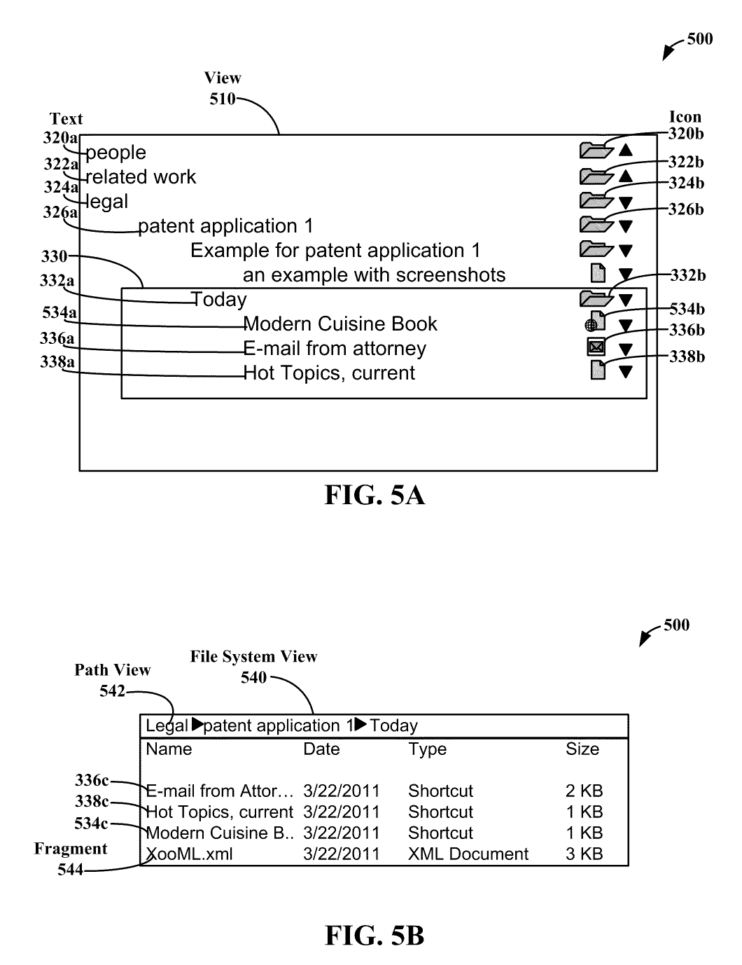

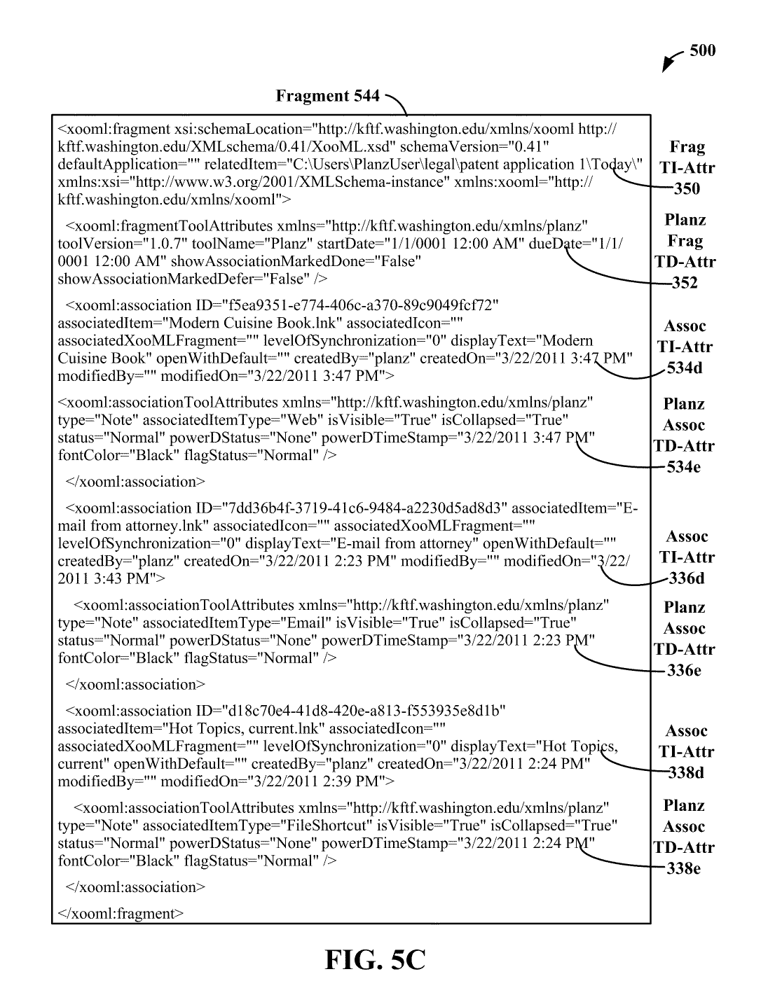

FIGS. 5A, 5B, and 5C together show an example scenario 500 for inserting an item into a plan using Planz. Scenario 500 continues scenario 400 discussed above in the contexts of FIGS. 4A-4C. Each of FIGS. 5A, 5B, and 5C show separate views of the plan at the same time: FIG. 5A shows a Planz-generated view after insertion of a “Modern Cuisine Book” item, FIG. 5B shows a file system view after insertion of the “Modern Cuisine Book” item, and FIG. 5C shows a corresponding XooML fragment.

FIG. 5A shows an example view 510 of a plan after an item has been inserted using Planz in accordance with an example embodiment. View 510 shows that an item with text “Modern Cuisine Book” 534a and icon 534b has been inserted. Icon 534b indicates that the “Modern Cuisine Book” item is a web document. FIG. 5A shows that the remainder of view 510 is the same as view 410 (shown in FIG. 4A).

FIG. 5B shows an example file system view 540 for part of the example plan shown in FIG. 5A in accordance with an example embodiment. FIG. 5B shows file system view 540 as including an item 534c for the inserted “Modern Cuisine Book” and a corresponding XooML fragment 544.

Upon insertion of an item using view 510, Planz updates view 510 to show the inserted item and associated information item; e.g., a web document about the “Modern Cuisine Book.” Planz also creates a link, copy, or shortcut to the corresponding information item in an associated folder. As such, FIG. 5B shows that item 534c has been created in the “Today” folder. Planz also updates the XooML fragment 544 to indicate insertion of the “Modern Cuisine Book” item. FIG. 5B shows that the remainder of file system view 540 is the same as file system view 440 (shown in FIG. 4B).

FIG. 5C shows an example XooML fragment 544 for the part of the example plan shown in FIG. 5B, in accordance with an example embodiment. To update a XooML fragment to add an item, a tool, such as Planz, can insert any tool-independent attributes for the item and any tool-dependent attributes for the tool into the fragment for the item. Fragment 544 shows insertion of a “xooml:association” tag with association-tool-independent attributes (“Assoc TI-Attr”) 534d and Planz association-tool-dependent attributes (“Planz Assoc TD-Attr”) 534e.

Association tool-independent attributes 534d include an association identifier (ID), an associated item which specifies a file name for the association shown in FIG. 5C as “Modern Cuisine Book.lnk”, an associated icon, an associated XooML fragment, a level of synchronization, display text, a createdBy attribute, a creation date, a modifiedBy attribute, and a modification date. Association tool-independent attributes 534d are the same attributes as used for association tool-independent attributes 336d and 338d, but have different values.

Association-tool-dependent attributes for Planz 534e include attributes for a name space, an association type, an associated item type of “Web” to indicated that the “Modern Cuisine Book” information item is a web document, a visibility flag, a collapsed flag, a status, a powerD status, a powerD time stamp, a font color, and a flag status. Association-tool-dependent attributes for Planz 534e are the same attributes as used for association-tool-dependent attributes for Planz 336e and 338e, but have different values. The remaining portions of fragment 544 are the same as fragment 444 (shown in FIG. 4C).

4. Item Update

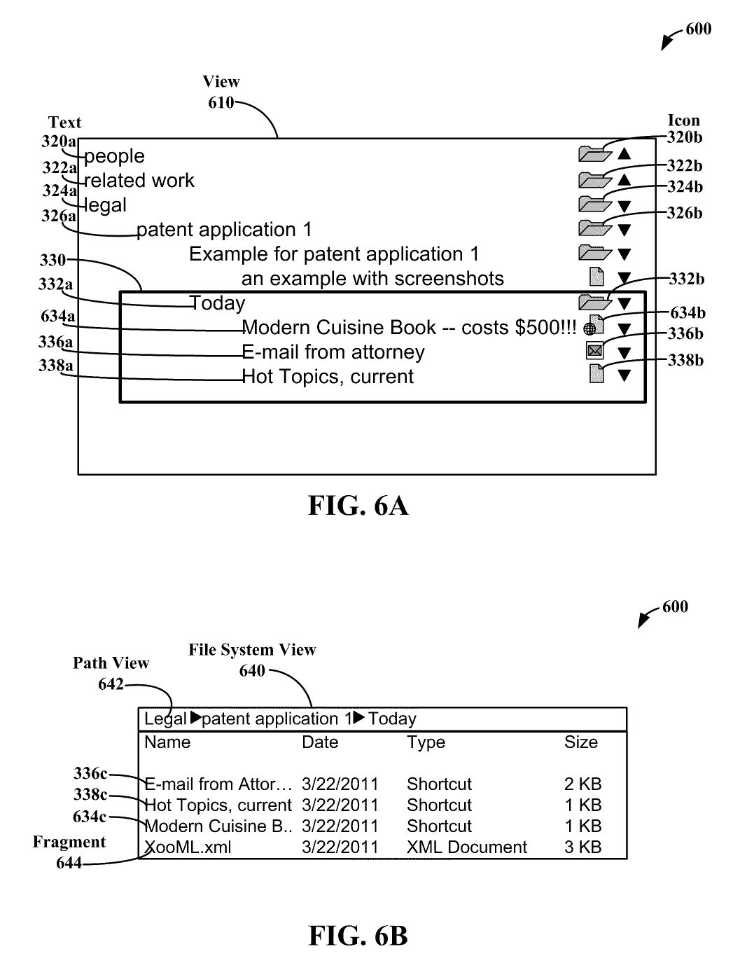

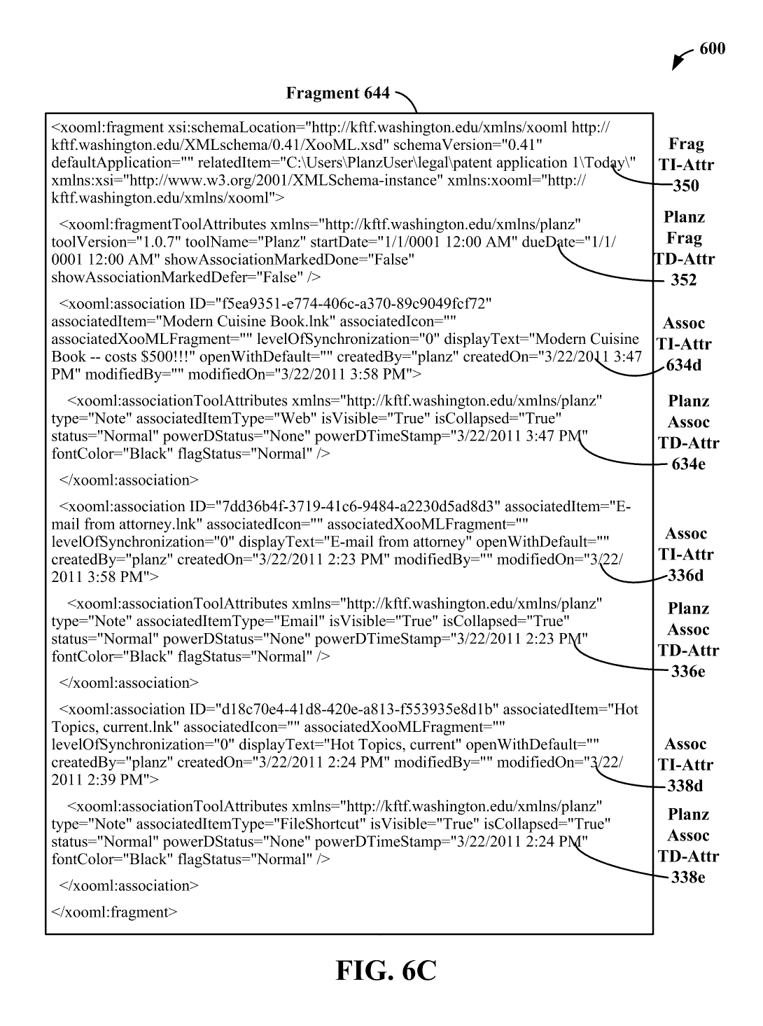

FIGS. 6A, 6B, and 6C together show an example scenario 600 for updating an item from a plan using Planz. Scenario 600 continues scenario 500 discussed above in the context of FIGS. 5A-5C. Each of FIGS. 6A, 6B, and 6C show separate views of the plan at the same time: FIG. 6A shows a Planz-generated view after updating the “Modern Cuisine Book” item discussed above, FIG. 6B shows a file system view after updating the “Modern Cuisine Book” item, and FIG. 6C shows a corresponding XooML fragment.

FIG. 6A shows an example view 610 of a plan after an item has been updated using Planz in accordance with an example embodiment. View 610 shows updated text 634a of “Modern Cuisine Book—costs $500!!!” for the “Modern Cuisine Book” item discussed above in the context of FIGS. 5A-5C. FIG. 6A shows that the remainder of view 610 is the same as view 510 (shown in FIG. 5A).

FIG. 6B shows an example file system view 640 for part of the example plan shown in FIG. 6A in accordance with an example embodiment. FIG. 6B shows file system view 640 with item 634c for the “Modern Cuisine Book” item and a corresponding XooML fragment 644. To update the text for the “Modern Cuisine Book”; also known as the “note,” Planz need not change the information item stored in the file system. Rather, the note can be updated by updating the XooML fragment alone. Thus, item 634c in view 640 of FIG. 6B is shown to be the same as item 534c in view 540 of FIG. 5B.

FIG. 6C shows an example XooML fragment 644 for the part of the example plan shown in FIG. 6B, in accordance with an example embodiment. As indicated above, the XooML fragment can be updated to change the note for an item. FIG. 6C shows that association-tool-independent attributes for the “Modern Cuisine Book” item 634d have been updated. Specifically, the “displayText” tool-independent attribute has been updated to have a value of “Modern Cuisine Book—costs $500!!!” and the modifiedOn attribute has been updated to indicate a time when association-tool-independent attributes 634d were modified. In some embodiments, a tool can update the modifiedBy attribute to indicate an identifier of a tool that updated association-tool-independent attributes 634d. The remaining portions of fragment 644 are the same as fragment 544 (shown in FIG. 4C).

Example Operations

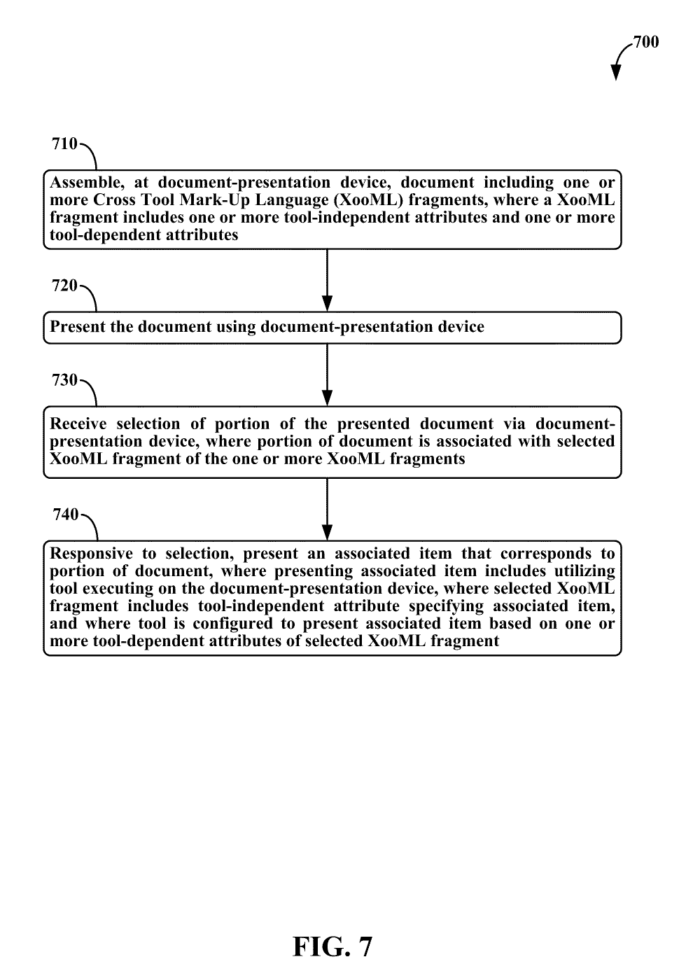

FIG. 7 is a flow chart of an example method 700 in accordance with an example embodiment. At block 710, a document is assembled at a document-presentation device, such as document-presentation device 104a, 104b, and/or 104c (shown in FIG. 1). The document includes one or more Cross Tool Mark-Up Language (XooML) fragments. A XooML fragment includes one or more tool-independent attributes and one or more tool-dependent attributes. Documents and XooML fragments are discussed above in the context of at least FIGS. 3A-6C.

In some embodiments, each XooML fragment comprises one or more XML statements. Example XooML fragments with XML statements are shown above in at least FIGS. 3C, 4C, 5C, and 6C.

In other embodiments, the XooML fragment can include one or more associations, where an association comprises one or more association-common attributes and one or more association-tool-specific attributes. XooML fragments with associations are discussed above in the context of at least FIGS. 3A-6C.

At block 720, the document-presentation device presents the document. Presenting documents and XooML fragments are discussed above in the context of at least FIGS. 3A-6C.

At block 730, the document-presentation device receives a selection of a portion of the document. The selected portion of the document corresponds to a XooML fragment. Selection of XooML documents is discussed above in the context of at least FIGS. 3A-6C.

At block 740, the document-presentation device, in response to the selection, presents an item that corresponds to the selected portion of the document. Presenting the item includes utilizing a software tool executing on the document-presentation device. The associated XooML fragment includes a tool-independent attribute specifying the item. The software tool can be configured to present the item based on one or more tool-dependent attributes of the associated XooML fragment. Display of items using XooML documents is discussed above in the context of at least FIGS. 3A-6C.

In other embodiments, the document and the item can be stored in a storage area of a file system accessible to the document-presentation device. Storage of documents and items in file systems is discussed above at least in the context of FIGS. 3B, 4B, 5B, and 6B.

In some of these other embodiments: (i) a new item can be added into the storage area, (ii) the document can be synchronized with the storage area, (iii) the new item can be discovered to have been added to the storage area, (iv) a XooML fragment associated with the storage area can be determined, and (v) the XooML fragment can be updated to include the new item. Synchronization of file systems and XooML fragments is discussed above at least in the context of FIGS. 3A, 3B, and 3C.

In still other of these other embodiments: (i) a removable item can be removed from the storage area, (ii) the document can be synchronized with the storage area, (iii) the removable item can be discovered to have been removed, (iv) a XooML fragment associated with the storage area can be determined, and (v) the XooML fragment can be updated to remove the removable item. Synchronization of file systems and XooML fragments is discussed above at least in the context of FIGS. 3A, 3B, and 3C.

In even other of these other embodiments, a new item can be added to the document by at least: (i) updating the document to modify an new XooML fragment corresponding to the new item and (ii) storing a representation of the new item in the storage area. An example scenario for adding a new item is discussed above in the context of FIGS. 5A-5C.

In yet other of these other embodiments, a removable item can be removed the document by at least: (i) updating the document to modify a XooML fragment corresponding to the removable item and (ii) deleting a representation of the removable item from the storage area. An example scenario for removing a removable item is discussed above in the context of FIGS. 4A-4C.

### CONCLUSION

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or message may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

Moreover, a block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. It should be understood that the word “exemplary” is used herein to mean “serving as an example, instance, or illustration.” Any embodiment described herein as “exemplary” is not necessarily to be construed as preferred or advantageous over other embodiments.

The preceding detailed description describes various features and functions of the disclosed systems, devices, and methods with reference to the accompanying figures. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

1. A method, comprising:
assembling, at a document-presentation device, a document comprising one or more Cross Tool Mark-Up Language (XooML) fragments, wherein a XooML fragment includes one or more tool-independent attributes and one or more tool-dependent attributes;
presenting the document using the document-presentation device;
receiving, via the document-presentation device, a selection of a portion of the document, wherein the selected portion of the document corresponds to a XooML fragment; and
responsive to the selection, presenting an item that corresponds to the selected portion of the document, wherein presenting the item comprises utilizing a software tool executing on the document-presentation device, wherein the associated XooML fragment includes a tool-independent attribute specifying the item, and wherein the software tool is configured to present the item based on one or more tool-dependent attributes of the associated XooML fragment.

2. The method of claim 1, wherein a XooML fragment further comprises one or more associations, and wherein an association comprises one or more association-common attributes and one or more association-tool-specific attributes.

3. The method of claim 1, wherein each XooML fragment comprises one or more eXtensible Markup Language (XML) statements.

4. The method of claim 1, further comprising:
storing the document and the item in a storage area of a file system accessible to the document-presentation device.

5. The method of claim 4, further comprising:
adding a new item into the storage area;
synchronizing the document with the storage area;
based on the synchronizing, discovering that the new item has been added to the storage area;
determining a XooML fragment associated with the storage area; and
updating the XooML fragment to include the new item.

6. The method of claim 4, further comprising:
removing a removable item from the storage area;
synchronizing the document with the storage area;
based on the synchronizing, discovering that the removable item has been removed;
determining a XooML fragment associated with the storage area; and
updating the XooML fragment to remove the removable item.

7. The method of claim 4, further comprising:
adding a new item to the document by at least:
updating the document to modify an XooML fragment corresponding to the new item; and
storing a representation of the new item in the storage area.

8. The method of claim 4, further comprising:
removing a removable item from the document by at least:
updating the document modify an XooML fragment corresponding to the removable item; and
deleting a representation of the removable item from the storage area.

9. An article of manufacture, comprising instructions that, upon execution by a processor, cause the processor to perform functions comprising:
assembling a document comprising one or more Cross Tool Mark-Up Language (XooML) fragments, wherein a XooML fragment comprises a tool-independent attribute and a tool-dependent attribute;
presenting the document;
receiving a selection of a portion of the document, wherein the selected portion of the document corresponds to an associated XooML fragment; and
responsive to the selection, presenting an item that corresponds to the selected portion of the document, wherein the item is presented using a software tool, wherein the selected XooML fragment comprises a tool-independent attribute specifying the item, and wherein the software tool is configured to present the item based on at least one tool-dependent attribute of the associated XooML fragment.

10. The article of manufacture of claim 9, wherein a XooML fragment further comprises one or more associations, and wherein an association comprises an association-common attribute and an association-tool-specific attribute.

11. The article of manufacture of claim 9, wherein each XooML fragment comprises one or more eXtensible Markup Language (XML) statements.

12. The article of manufacture of claim 9, wherein the functions further comprise:
storing the document and the item in a storage area of a file system.

13. The article of manufacture of claim 12, wherein the functions further comprise:
adding a new item to the document by at least:
updating the document to modify a XooML fragment corresponding to the new item; and
storing a representation of the new item in the storage area.

14. The article of manufacture of claim 12, wherein the functions further comprise:
removing a removable item from the document by at least:
updating the document to modify a removable XooML fragment corresponding to the removable item; and
deleting a representation of the removable item from the storage area.

15. A document-presentation device, comprising:
a presentation device; and
one or more processors configured to:
assemble a document comprising one or more Cross Tool Mark-Up Language (XooML) fragments, wherein at least one XooML fragment comprises a tool-independent attribute and a tool-dependent attribute;
present the document via the presentation device;
receive a selection of a portion of the document, wherein the selected portion of the document is associated with a corresponding XooML fragment; and
responsive to the selection, presenting an item that corresponds to the selected portion of the document, wherein the item is presented on the presentation device using a tool, wherein the corresponding XooML fragment comprises a tool-independent attribute specifying the item, and wherein the tool is configured to present the item based on one or more tool-dependent attributes of the corresponding XooML fragment.

16. The document-presentation device of claim 15, wherein the at least one XooML fragment further comprises one or more associations, and wherein an association comprises one or more association-common attributes and one or more association-tool-specific attributes.

17. The document-presentation device of claim 15, wherein each of the one or more XooML fragments comprises one or more eXtended Markup Language (XML) statements.

18. The document-presentation device of claim 15, further comprising:
a memory device, comprising a file system; and
wherein the one or more processors are further configured to store the document and the item in the file system.

19. The document-presentation device of claim 18, wherein the one or more processors are further configured to add a new item to the document by at least:
updating the document to modify a XooML fragment corresponding to the new item; and
storing a representation of the new item in the file system.

20. The document-presentation device of claim 18, wherein the one or more processors are further configured to remove a removable item from the document by at least:
updating the document to modify a removable-XooML fragment corresponding to the removable item; and
deleting a representation of the removable item from the file system.
